(19) United States
(12) Patent Application Publication
(10) Pub. No.: US 2002/0157956 A1
(43) Pub. Date: Oct. 31, 2002

(54) Hole structure and production method for hole structure

(76) Inventor: Tomoo Ikeda, Saitama (JP)

Correspondence Address: Finnegan Henderson Farabow Garrett & Dunner, 1300 I Street NW, Washington, DC, 20005-3315, US

(21) Appl. No.: 09/959,909

(22) PCT Filed: Mar. 22, 2001
(86) PCT No.: PCT/JP01/02305

(30) Foreign Application Priority Data
Mar. 22, 2000 (JP) 2000-79829
Feb. 15, 2001 (JP) 2001-37875

(51) Int. Cl. C25D 1/08; C25D 5/02; B32B 3/10

(52) U.S. Cl. 205/75; 205/118; 428/131

(57) ABSTRACT

The invention provides a hole structure through which is formed a deep through-hole having microscopic open ends, and also provides a method of fabricating the same. The hole structure of the invention contains a through-hole having a first open end and a second open end larger in size than the first open end, wherein the size, d, of the second open end is not smaller than 2 μm and not larger than 50 μm, and the through-hole has a depth t larger than d but not larger than 15d. The fabrication method of the invention comprises the steps of: forming an electrically conductive opaque layer in a prescribed pattern over a transparent substrate; forming a layer of insoluble photosensitive material on one side of the transparent substrate where the electrically conductive opaque layer is formed; applying exposure to the insoluble photosensitive material layer from the other side of the transparent substrate where the electrically conductive opaque layer is not formed; developing the insoluble photosensitive material and thereby forming a resist that matches the prescribed pattern; and forming the hole structure by electroplating on the one side where the resist has been formed.

### TECHNICAL FIELD

The present invention relates to a hole structure with a deep, microscopic hole opened therethrough, and a method of fabricating the same.

### BACKGROUND ART

A hole structure with a microscopic hole formed therethrough can be fabricated by various machining methods. The most commonly practiced machining method is by mechanical working (cutting) which forms a hole by drilling. Recent advances in machining tools have made it possible to drill a microscopic hole as small as about 60 μm in diameter.

Another machining method is by etching. Etching is a chemical machining method that forms desired holes by selectively dissolving a workpiece, typically a metal plate, in an acid solution. Compared with the mechanical machining method, the chemical machining method by etching has the characteristic of being able to form not only holes circular in shape, but also holes of other shapes such as rectangular or triangular holes.

Still another method is by pressing, which opens holes in a plate-like workpiece. Pressing is a method that punches holes in a plate-like workpiece by a mold of a desired shape, and is particularly suited for working thin plates. Further, this method increases productivity, since it can form many holes simultaneously in a single operation.

All of the above methods are methods of forming holes in a workpiece. There are other methods which fabricate a hole structure by growing a material in portions other than the portions where holes are formed. One such fabrication method is a process called electroforming. Electroforming is a fabrication method that forms a structure by using an electroplating technique.

Two prior art electroforming methods will be described below. The first prior art electroforming method will be described with reference to FIGS. 18(a) and 18(b). First, an insulating photosensitive material 530 is deposited on an electrically conductive substrate 520. Preferably, the photosensitive material 530 is deposited to a thickness of about 1 μm. The photosensitive material 530 is patterned in a desired shape (for example, circular shape) by using an ordinary photolithographic technique.

Next, an electroforming material 510 is precipitated by electroforming for deposition on the electrically conductive substrate 520 on which the photosensitive material 530 has been deposited. Basically, the electroforming process uses the principle of electroplating; therefore, the deposited electroforming material 510 grows isotropically by plating in directions shown by arrows from portions where the photosensitive material 530 is not formed. The electroforming material 510 is allowed to grow by plating until the desired shape (shown by dashed lines in FIG. 18(b)) is obtained.

Finally, the substrate 520 and the photosensitive material 530 are removed (o complete the fabrication of the hole structure 510 shown in FIG. 18(a). FIG. 18(a) is a diagram showing a cross section of the hole structure 510 fabricated by the first electroforming method.

Each through-hole 511 formed through the hole structure 510 has an interior shape resembling an inside-out umbrella and having one small open end and one large open end. Since the electroforming material grows isotropically by plating, the size, d2, of the large open end of the through-hole is determined by the thickness of the hole structure 510. Here, the thickness of the hole structure 510 can be considered to be equal to the depth, t, of the through-hole, as the photosensitive material 530 is very thin. More specifically, the relationship between the size, d2, of the large open end of the through-hole and the depth, t, of the through-hole and the relationship between the size, d2, of the large open end of the through-hole and the pitch, b, between each through-hole can be defined by the following expressions.

d2=d1+2×t

b>d1+2×t

As a result, with the first electroforming method, it has not been possible to form through-holes 511 deeper than one-half the size, d2, of the large open end thereof. Moreover, it has not been possible to make the pitch, b, between each through-hole 511 smaller than twice the depth, t, thereof.

In the case of d1=t, it follows from the above equation that d2>3t. In that case, when the area of the smaller open end of the through-hole is denoted by s1, and the area of the larger open end by s2, then ratio (s2/s1)>9, and thus it has not been possible to make the ratio (s2/s1) equal to or smaller than 9.

Next, the second prior art electroforming method will be described with reference to FIGS. 19(a) to 19(e). First, a photosensitive material 640 is deposited relatively thick over an electrically conductive substrate 620 (see FIG. 19(a)). The photosensitive material 640 needs to be formed thicker than the hole structure 610 to be fabricated.

Then, the photosensitive material 640 is selectively exposed to ultraviolet radiation through an exposure mask 630 formed so as to let ultraviolet radiation pass only through desired portions (see FIG. 19(b)). This exposure method is similar to those commonly employed in LSI fabrication, and is called the front exposure method.

Next, the photosensitive material 640 is developed by using a special developer, thus forming a patterned resist 650 (see FIG. 19(c)). It is empirically known that generally the pattern dimension, dr, of the pattern that can be formed by this method is not smaller than the thickness, tr, of the resist 650. To form a small pattern, therefore, the thickness, tr, of the resist 650 must be reduced.

Next, the hole structure 610 is formed by electroforming on the substrate 620 (see FIG. 19(d)).

Finally, the substrate 620 and the resist 650 are removed from the hole structure 610 (see FIG. 19(e)). Each through-hole 611 in the completed hole structure 610 has an interior shape that matches the shape of the resist 650. Accordingly, the open end size of the through-hole 611 is the same as the pattern dimension, dr, of the resist 650, while the depth, t, of the through-hole 611 is not larger in dimension than the thickness, tr, of the resist 650. As a result, the depth, t, of the through-hole 611 formed in the completed structure is always smaller in dimension than its open end size d.

As previously noted, with the mechanical machining method using a drill, it has not been possible to form a through-hole smaller than 60 μm in diameter. Further, the open end shape of the through-hole has been limited to a circular or elliptical shape. Moreover, productivity has been extremely low because the through-holes have had to be formed one by one.

With the etching method, on the other hand, the open end size of the through-hole that can be formed is determined by the depth of the hole to be opened by etching. That is, it has not been possible to make the depth of the through-hole greater than the open end dimension thereof. Therefore, it has not been possible to form deep through-holes.

With the press method also, it has not been possible to make the depth of the through-hole greater than the open end dimension thereof. Therefore, it has not been possible to form deep microscopic through-holes. Further, the press method requires that the workpiece be strong enough to withstand the large pressure applied to form the through-holes. However, when the pitch between each through-hole is made small, the workpiece cannot withstand the large pressure. As a result, when forming through-holes at small pitch, it has not been possible to use the press method.

In the case of the hole structure fabricated by the first prior art electroforming method, each through-hole has a unique interior shape characterized by a curved shape whose radius is approximately equal to the depth, t, of the through-hole, as shown in FIG. 18(a). As a result, while the size, d1, of one open end could be made smaller, it has not been possible to make the size, d2, of the other open end smaller in dimension than twice the depth, t, of the through-hole. In other words, it has not been possible to make the depth of the through-hole greater in dimension than the size, d2, of the larger open end thereof. Furthermore, it has not been possible to make the pitch, b, between through-hole smaller than twice the depth, t, thereof. That is, it has not been possible to arrange the through-holes at reduced pitch.

On the other hand, in the case of the hole structure fabricated by the second prior art electroforming method, it has not been possible to make the depth, t, of the through-hole greater in dimension than the size, d2, of the larger open end thereof, as shown in FIG. 19(e).

As described above, none of the prior art fabrication methods has been able to fabricate a hole structure through which is formed a deep through-hole having microscopic open ends.

An object of the invention is to provide a hole structure through which is formed a deep through-hole having microscopic open ends, and a method of fabricating the same.

Another object of the invention is to provide a hole structure fabrication method that can form many holes at a time so as to increase productivity.

A further object of the invention is to provide a manufacturing method that repeatedly carries out a fabrication method for fabricating a hole structure through which is formed a deep through-hole having microscopic open ends.

### DISCLOSURE OF THE INVENTION

To achieve the above objects, a hole structure fabrication method according to the present invention comprises the steps of: forming an electrically conductive opaque layer in a prescribed pattern over a transparent substrate; forming a layer of insoluble photosensitive material on one side of the transparent substrate where the electrically conductive opaque layer is formed; applying exposure to the insoluble photosensitive material layer from the other side of the transparent substrate where the electrically conductive opaque layer is not formed; developing the insoluble photosensitive material and thereby forming a resist that matches the prescribed pattern; and forming a hole structure by electroplating on the one side where the resist has been formed.

To achieve the above objects, a hole structure according to the present invention contains a through-hole having a first open end and a second open end not smaller in size than the first open end, wherein the hole structure is formed by back exposure and electroforming processes, the through-hole has an interior shape corresponding to the shape of the resist, the size, d, of the second open end is not smaller than 2 μm and not larger than 50 μm, and the through-hole has a depth t larger than d but not larger than 15d.

Further, to achieve the above objects, a hole structure according to the present invention contains a through-hole having a first open end and a second open end not smaller in size than the first open end, wherein the size, d, of the second open end is not smaller than 2 μm and not larger than 50 μm, and the through-hole has a depth t larger than d but not larger than 15d.

Preferably, the ratio of the area, s2, of the second open end to the area, s1, of the first open end (s2/s1) is set not smaller than 1 and not larger than 9.

Preferably also, the angle e that the inner wall of the through-hole makes with the centerline of the through-hole is set not smaller than 0° and not larger than 12°.

### ADVANTAGEOUS EFFECT OF THE INVENTION

According to the present invention, by using the back exposure process, it becomes possible to provide a hole structure through which is formed a deep through-hole having microscopic open ends, and a method of fabricating the same. Furthermore, according to the present invention, it also becomes possible to design and make not only through-holes having circular or elliptical open ends but also through-holes having polygonally shaped open ends, which has not been possible with the mechanical working method (cutting method) using a drill.

Further, according to the present invention, by using the back exposure process, it becomes possible to provide a hole structure fabrication method that can form many through-holes at a time so as to increase productivity.

Furthermore, according to the present invention, it becomes possible to provide a fabrication method that repeatedly carries out the hole structure fabrication method and thereby fabricates a hole structure having a deeper through-hole with microscopic open ends. In such a hole structure, through-holes formed in a plurality of structures are connected together to form a deeper through-hole.

### BRIEF DESCRIPTION OF THE DRAWINGS

FIG. 1(a) is a diagram showing a patterning step in a first fabrication method according to the present invention, FIG. 1(b) is a diagram showing a coating step, FIG. 1(c) is a diagram showing an exposing step, FIG. 1(d) is a diagram showing a developing step, and FIG. 1(e) is a diagram showing an electroforming step.

FIG. 2(a) is a cross-sectional view of a hole structure fabricated by the first fabrication method of the present invention, and FIG. 2(b) is a perspective view of the structure shown in FIG. 2(a).

FIG. 3(a) is a diagram showing an exposing step using a front exposure method, and FIG. 3(b) is a diagram showing a structural example of a resist formed in the step shown in FIG. 3(a).

FIG. 4(a) is a cross-sectional view of another hole structure fabricated by the first fabrication method of the present invention, and FIG. 4(b) is a diagram showing the structure of a resist corresponding to FIG. 4(a).

FIG. 5(a) is a cross-sectional view of another hole structure fabricated by the first fabrication method of the present invention, and FIG. 5(b) is a diagram showing the structure of a resist corresponding to FIG. 5(a).

FIG. 6 is a cross-sectional view of still another hole structure fabricated by the first fabrication method of the present invention.

FIG. 7 is a cross-sectional view of yet another hole structure fabricated by the first fabrication method of the present invention.

FIG. 8(a) is a diagram showing a patterning step in a second fabrication method according to the present invention, FIG. 8(b) is a diagram showing a coating step, FIG. 8(c) is a diagram showing an exposing step, FIG. 8(d) is a diagram showing a developing step, and FIG. 8(e) is a diagram showing an electroforming step.

FIG. 9(a) is a diagram showing a second resist removing step in the second fabrication method of the present invention, FIG. 9(b) is a diagram showing a second patterning step, FIG. 9(c) is a diagram showing a second exposing step, FIG. 9(d) is a diagram showing a second developing step, FIG. 9(e) is a diagram showing a second electroforming step, and FIG. 9(f) is a diagram showing a hole structure fabricated by the second fabrication method.

FIG. 10(a) is a diagram showing the n-th resist removing step in the second fabrication method of the present invention, FIG. 10(b) is a diagram showing the n-th patterning step, FIG. 10(c) is a diagram showing the n-th exposing step, FIG. 10(d) is a diagram showing the n-th developing step, FIG. 10(e) is a diagram showing the n-th electroforming step, and FIG. 10(f) is a diagram showing another hole structure fabricated by the second fabrication method

FIG. 11 is a diagram showing a first application example of the hole structure of the present invention.

FIG. 12 is a diagram showing a second application example of the hole structure of the present invention.

FIG. 13 is a diagram showing a third application example of the hole structure of the present invention.

FIG. 14 is a diagram showing a fourth application example of the hole structure of the present invention.

FIG. 15 is a diagram showing a fifth application example of the hole structure of the present invention.

FIG. 16 is a diagram showing a sixth application example of the hole structure of the present invention.

FIG. 17 is a diagram showing a seventh application example of the hole structure of the present invention.

FIG. 18(a) is a cross-sectional view of a hole structure fabricated by a first prior art electroforming method, and FIG. 18(b) is a diagram for explaining the first prior art electroforming method.

FIG. 19(a) is a diagram showing a coating step in a second prior art electroforming method, FIG. 19(b) is a diagram showing an exposing step, FIG. 19(c) is a diagram showing a developing step, FIG. 19(d) is a diagram showing an electroforming step, and FIG. 19(e) is a diagram showing a stripping step.

### BEST MODE FOR CARRYING OUT THE INVENTION

A first fabrication method according to the present invention will be described below.

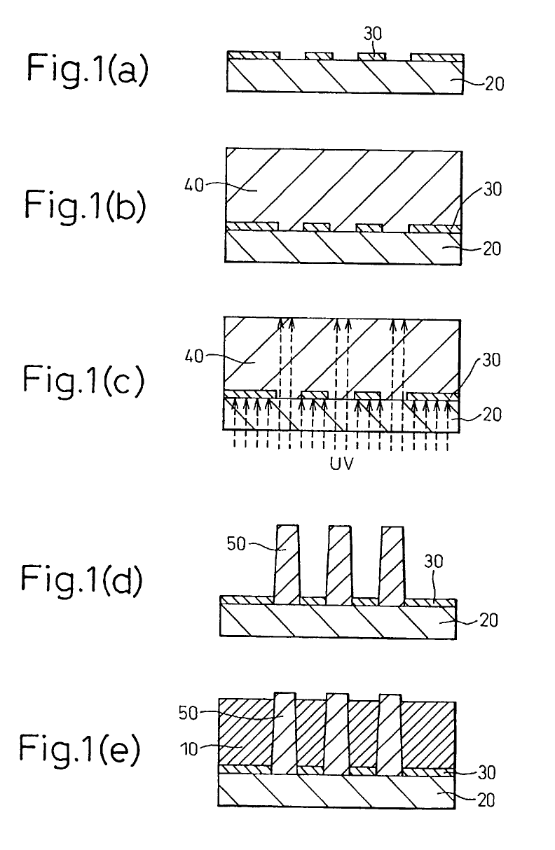

FIG. 1 is a diagram schematically illustrating the first fabrication method of the present invention. First, as shown in FIG. 1(a), an electrically conductive opaque layer 30 is formed and patterned in a desired shape over a transparent substrate 20. The patterning is done using the techniques of photolithography and etching commonly employed in LSI fabrication. Using these techniques, the pattern can be formed with a precision of micron order.

In the illustrated example, a borosilicate glass 0.4 mm in thickness was used for the transparent substrate 20. The electrically conductive opaque layer 30 was constructed using a multi-layer structure consisting of a lower layer (on the transparent substrate 20 side) formed from a 0.05-μm thick chromium (Cr) film and an upper layer formed from a 0.2-μm thick gold (Au) film. The upper and lower layers of the electrically conductive opaque layer 30 were formed by sputtering, which is a form of vacuum film deposition. Then, using the techniques of photolithography and etching, the pattern was formed by etching circular holes 20 μm in diameter and spaced 40 μm from center to center (i.e., at a pitch of 40 μm).

Next, as shown in FIG. 1(b), an insoluble photosensitive material 40 is deposited to a specified thickness on one side of the transparent substrate 20 where the electrically conductive opaque layer 30 is formed. In the illustrated example, negative resist THB-130N (brand name) manufactured by JSR was used for the insoluble photosensitive material 40, and was deposited by spin coating to a thickness of 60 μm. The spin coating was performed for 10 seconds at 1000 rpm.

Then, as shown in FIG. 1(c), ultraviolet radiation (UV) is applied from the other side of the transparent substrate 20 where the electrically conductive opaque layer 30 is not formed. The insoluble photosensitive material 40 is exposed to the ultraviolet radiation passing through the transparent substrate 20. In the illustrated example, the insoluble photosensitive material 40 was illuminated by ultraviolet light with an energy density of 450 mJ/cm². In this case, the insoluble photosensitive material 40 is exposed according to the pattern of the electrically conductive opaque layer 30 as the patterned electrically conductive opaque layer 30 acts as a mask during the exposure. As previously described, the pattern consists of circularly etched holes 20 μm in diameter and spaced 40 μm from center to center. The method in which the insoluble photosensitive material formed on the transparent substrate is exposed from the underside of the transparent substrate as described above is called back exposure. By contrast, the method in which the insoluble photosensitive material formed on the substrate is exposed from the same side where the insoluble photosensitive material is formed is called front exposure.

The insoluble photosensitive material 40 is a material which becomes insoluble only in exposed areas. Therefore, in the developing step that follows the exposing step shown in FIG. 1(c), the unexposed portions of the insoluble photosensitive material 40 are removed, leaving the resist 50 shown in FIG. 1(d). For development, a liquid developer special for the negative resist THB-130N (brand name) manufactured by JSR was used, and the developing was performed for two minutes at a liquid temperature of 40° C.

The resist 50 has a pattern that matches the pattern of the electrically conductive opaque layer 30. The resist 50 therefore has a shape substantially resembling a cylinder, that is, the bottom (the side contacting the transparent substrate 20) is circular in shape with a diameter of 20 μm, the top is also circular but is slightly smaller than the bottom, and the height is 60 μm. One reason that the shape of the resist 50 is not a perfect cylinder is presumably because the ultraviolet radiation undergoes diffraction at the edges of the electrically conductive opaque layer 30 and is bent inwardly. Another reason that the shape of the resist 50 is not a perfect cylinder is presumably because the amount of exposure to the ultraviolet radiation decreases with decreasing distance to the top of the resist 50, making the insoluble photosensitive material 40 easier to develop.

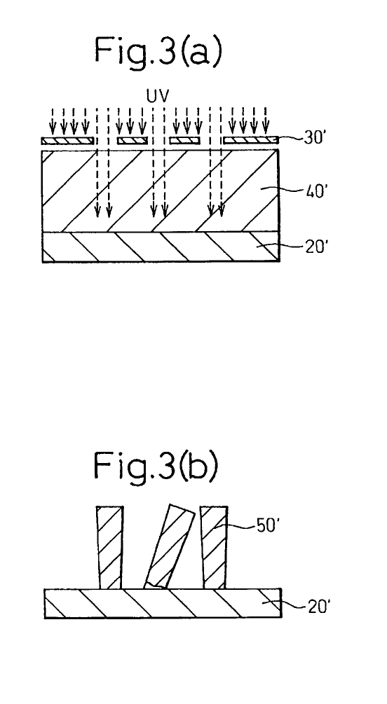

The reason that the resist 50 of such a height can be formed is probably because the back exposure method is used. For the reasons described above, when the insoluble photosensitive material 40 is exposed, the resist when developed becomes gradually thinner toward the end thereof opposite the end exposed to the radiation. Accordingly, if front exposure is employed as shown in FIG. 3(a), the resist when developed will become thinner toward its bottom as shown in FIG. 3(b). If the bottom of the resist is thin, the resist can easily collapse and cannot serve its purpose as a resist. This phenomenon becomes more pronounced as the height of the resist increases. Therefore, with the front exposure method, it has not been possible to form a resist that is taller than it is wide. By contrast, if the back exposure method is used, a tall resist can be formed because the resist then becomes thinner toward its top.

Next, as shown in FIG. 1(e), the hole structure 10 is formed by electroforming on the electrically conductive opaque layer 30. Electroforming is a method in which a structure is formed by depositing a plating material onto an electrode surface by electroplating. In FIG. 1(e), the plating material is deposited on the electrically conductive opaque layer 30 which serves as the electrode in electroforming. Since the plating material is not deposited on the resist 50, the hole structure 10 with through-holes 100 formed therein, each having an interior shape that matches the shape of the resist 50, can be constructed as shown. In the illustrated example, the hole structure of nickel (Ni) was formed to a thickness of 50 μm by Ni electroforming.

In the Ni electroforming process, sulphamic acid Ni was used as the plating material, and the electroforming was performed with a current density of 1 A/dm² for five hours in an aqueous solution held at 50° C. Here, the electrically conductive opaque layer 30 served as the exposure mask for the back exposure as well as the electrode in electroforming.

In the illustrated example, the hole structure 10 made of Ni was formed by Ni electroforming, but it will be appreciated that the material is not limited to Ni. Since electroforming is one form of electroplating, the hole structure described above can be fabricated using any kind of material as long as the material can be deposited by electroplating. Besides Ni, examples of materials that can be used for electroplating include Cu, Co, Sn, Zn, Au, Pt, Ag, Pb, and their alloys.

Finally, the resist 50, the electrically conductive opaque layer 30, and the transparent substrate 20 were removed to complete the fabrication of the hole structure 10. Here, the resist 50 was removed by dissolving it in an aqueous solution of 10% potassium hydroxide (KOH) held at 50° C., and the electrically conductive opaque layer 30 and the transparent substrate 20 were removed mechanically.

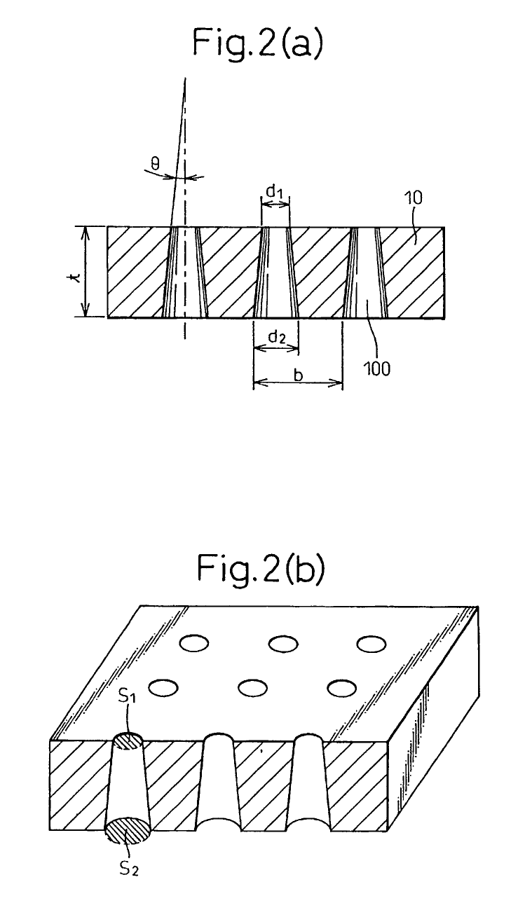

The thus-fabricated hole structure 10 is shown in FIGS. 2(a) and 2(b). FIG. 2(a) is a cross-sectional view of the hole structure 10, and FIG. 2(b) is a perspective view of the hole structure. As shown, each through-hole 100 formed in the hole structure 10 has a first open end (on the upper layer side of the insoluble photosensitive material 40) and a second open end (on the electrically conductive opaque layer 30 side) which is larger than the first open end. Here, the depth of the through-hole 100 is denoted by t, the size of the first open end by d1, and the size of the second open end by d2. Further, the area of the first open end is denoted by s1, and the area of the second open end by s2. The angle that the inner wall of the through-hole 100 makes with the centerline of the through-hole 100 (that is, the angle between the centerline of the through-hole and the line joining the edge of the first open end to the edge of the second open end of the through-hole) is denoted by θ. Then, in FIG. 2, tanθ=(d2−d1)/2t. In this specification, the open end size is defined as the diameter of the circle that is tangent internally to the hole opening appearing at the surface of the hole structure.

More specifically, the through-holes 100 formed in the hole structure 10 were such that the size, d1, of the first open end was 18 μm (circular), the size, d2, of the second open end was 20 μm (circular), the depth t was 50 μm, and the angle θ was 1.15°. The ratio of the area, s2, of the second open end to the area, s1, of the first open end (s2/s1) was 1.11, and the pitch b between each through-hole 100 was 40 μm.

According to the first fabrication method described above, the size, d2, of the second open end of the through-hole can be set not larger than 50 μm and not smaller than 2 μm, and the depth, t, of the through-hole can be set larger than d2 but smaller than 5.5×d2.

Furthermore, the ratio of the area of the second open end to the area of the first open end of the through-hole (s2/s1) can be set not smaller than 1 and not larger than 9.

It is also possible to set the angle θ of the through-hole not smaller than 0° and not larger than 12°. The resist becomes smaller in size toward its end for the previously given reasons such as diffraction. However, it has been found by experimentation that, in the hole structure of the present invention, the angle of the inner wall of the through-hole does not become larger than 12°.

It is also possible to set the pitch b between each through-hole smaller than 2×d2.

As previously explained in the description of the prior art, with the mechanical working method using a drill, the open end size (for example, d2) of the through-hole cannot be made smaller than 60 μm. Furthermore, with any of the etching method, the press method, the first prior art electroforming method, and the second prior art electroforming method, it has not been possible to make the depth of the through-hole greater than the open end size thereof.

Therefore, it has not been possible with the prior art to fabricate, for example, a hole structure whose open end size d2 is 50 μm or less and whose depth t is larger than d2. The fabrication of a hole structure having such features is made possible for the first time by the fabrication method employing the back exposure and electroforming processes described above.

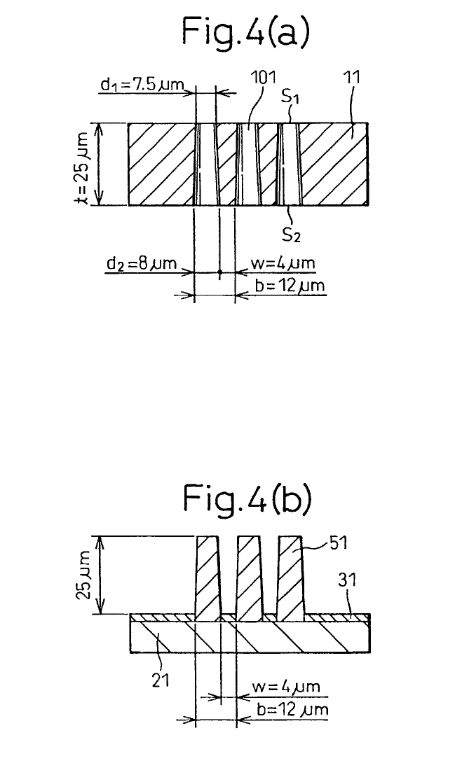

FIGS. 4(a) and 4(b) show another hole structure 11 fabricated by the above-described first fabrication method and the resist 51 used for the fabrication of the hole structure 11. FIG. 4(b) shows the structure of the resist 51 after the developing step but before the electroforming step, and corresponds to the structure previously shown in FIG. 1(d).

Through-holes 101 formed in the hole structure 11 were such that the size, d1, of the first open end was 7.5 m (circular), the size, d2, of the second open end was 8 μm (circular), the depth t was 25 Mm, and the angle θ was 0.570. The ratio of the area, s2, of the second open end to the area, s1, of the first open end (s2/s1) was 1.14, and the pitch b between each through-hole 101 was 12 Sm. The width, w, of the wall separating each through-hole 101 was 4 μm.

In the hole structure 11 shown in FIG. 4(a), the size, d2, of the second open end of each through-hole 101 and the pitch b between each through-hole 101 were reduced compared with the hole structure 10 shown in FIG. 1. The various features of the hole structure 11 all satisfy the previously described conditions set for the size, d2, of the second open end (not larger than 50 μm and not smaller than 2 μm), the depth t (not smaller than d2 but smaller than 5.5×d2), the area ratio (s2/s1) (not smaller than 1 and not larger than 9), the angle θ (not smaller than 0° and not larger than 12°), and the pitch b (not larger than 2×d2).

In the first prior art electroforming method shown in FIG. 18, the pitch, b, of the hole structure cannot be made smaller than twice the depth, t, of the through-hole no matter how small the first open end size, d1, of the through-hole is made. By contrast, according to the first fabrication method of the present invention, the pitch between each through-hole can be set without regard to the depth, t, of the through-hole 101. Therefore, with the first fabrication method of the present invention, the through-hole pitch b can be set extremely small compared with the first prior art electroforming method.

The great reduction in the through-hole pitch b has been made possible presumably because of the use of the back exposure and electroforming processes.

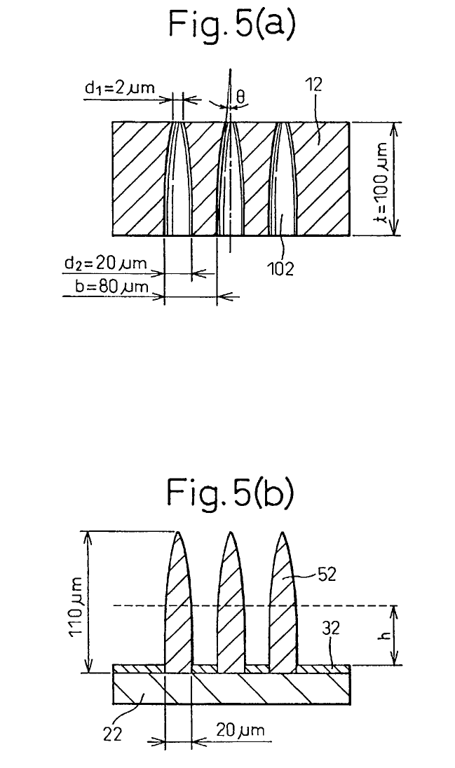

FIGS. 5(a) and 5(b) show another hole structure 12 fabricated by the above-described first fabrication method and the resist 52 used for the fabrication of the hole structure 12. FIG. 5(b) shows the structure of the resist 52 after the developing step but before the electroforming step, and corresponds to the structure previously shown in FIG. 1(d).

Through-holes 102 formed in the hole structure 12 were such that the size, d1, of the first open end was 2 μm (circular), the size, d2, of the second open end was 20 μm (circular), the depth t was 100 μm, and the angle θ was 5.14°. The pitch b between each through-hole 102 was 80 μm.

In the hole structure 12 shown in FIG. 5(a), the depth, t, of the through-hole 102 is made larger than that in the hole structure 10 shown in FIG. 1. As shown in FIG. 5(b), the resist 52 has a pointed shape resembling a circular cone having a height of 110 μm and a circular base 20 μm in diameter. When the resist height is increased as shown, the top becomes narrower than the bottom, and eventually, the resist is formed in a pointed shape.

However, when the resist 52 is closely examined, it can be seen that the resist 52 is formed substantially vertically up to about ½ (indicated by h) of the resist height. In this way, it has been found, as a result of our experimentation, that the resist is formed substantially vertically up to ½ of the resist height when the resist is formed by back exposure.

The various features of the hole structure 12 all satisfy the previously described conditions set for the size, d2, of the second open end (not larger than 50 μm and not smaller than 2 μm), the depth t (not smaller than d2 and smaller than 5.5×d2), the angle θ (not smaller than 0° and not larger than 12°), and the pitch b (not larger than 2 ×d2).

From the condition of FIG. 5(b), electroforming was performed by extending the processing time to 10 hours to form the hole structure of Ni with a thickness of 100 μm. The other processing conditions are the same as those for the structure of FIG. 1(e). After that, the resist 52, the electrically conductive opaque layer 32, and the transparent substrate 22 were removed to complete the fabrication of the hole structure 12.

As shown in FIG. 5(a), the size, d1, of the first open end of the through-hole 102 is 2 μm, while the size, d2, of the second open end is 20 μm. This means that the shape of the resist 52 shown in FIG. 5(b) has been precisely transferred into the through-hole 102 by electroforming. If the hole structure were formed to a thickness of 110 μm or greater by further extending the processing time in the electroforming step, the through-hole 102 could not be formed, because the hole would then be closed at the top. That is, in the illustrated example, the depth, t, of the through-hole cannot be made equal to or larger than 5.5×d2. Accordingly, the first fabrication method is particularly effective when the depth, t, of the through-hole is not larger than 5×d2. If a second fabrication method according to the present invention is employed, however, it becomes possible to further increase the depth, t, of the through-hole. The second fabrication method of the invention will be described later.

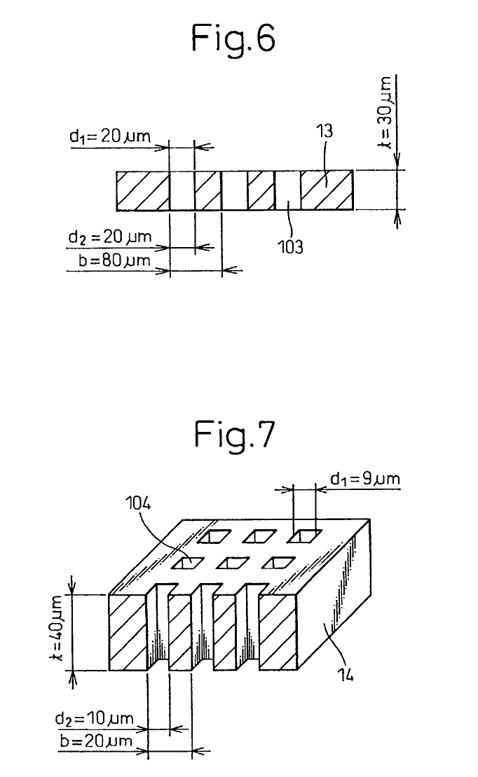

FIG. 6 is a cross-sectional view showing still another hole structure 13 fabricated by the first fabrication method.

Through-holes 103 formed in the hole structure 13 were such that the size, d1, of the first open end was 20 μm (circular), the size, d2, of the second open end was 20 μm (circular), the depth t was 30 μm, and the angle θ was 0°. The ratio of the area, s2, of the second open end to the area, s1, of the first open end (s2/s1) was 1.00, and the pitch b between each through-hole 103 was 80 μm.

The various features of the hole structure 13 all satisfy the previously described conditions set for the size, d2, of the second open end (not larger than 50 μm and not smaller than 2 μm), the depth t (not smaller than d2 and smaller than 5.5×d2), the area ratio (s2/s1) (not smaller than 1 and not larger than 9), the angle θ (not smaller than 0° and not larger than 12°), and the pitch b (not larger than 2×d2).

The hole structure 13 was fabricated by depositing Ni to a thickness of 30 μm by extending the processing time in the electroforming step to three hours. The other processing conditions are the same as those for the structure of FIG. 1(e).

As shown in FIG. 6, the size, d1, of the first open end and the size, d2, of the second open end of the through-hole 103 are both 20 μm. In this way, through-holes whose inner walls are not tapered but stand vertically up to the surface of the hole structure 13 could be formed in the hole structure 13. That is, when the hole structure is relatively thin, through-holes whose inner walls are not tapered but stand vertically can be formed in the hole structure. In other words, in FIG. 6, since the hole structure was formed not exceeding ½ of the resist height (110 μm, see FIG. 5(b), through-holes whose size is the same in any cross section could be opened in the hole structure.

The depth, t, of the through-hole 13 in the hole structure 13 shown in FIG. 6 is 30 μm, but if the thickness of the hole structure is further reduced, a shallower through-hole can be formed. In that case, however, when the depth, t, of the through-hole is equal to or smaller than the open end size d2, the prior art electroforming method or other suitable prior art method can be used instead of the first fabrication method of the invention; accordingly, the present invention is particularly effective when the depth, t, of the through-hole is not smaller than 1.5×d2.

Therefore, the first fabrication method of the invention is particularly preferable when the depth, t, of the through-hole is not smaller than 1.5×d2 and not larger than 5×d2.

FIG. 7 is a cross-sectional view showing yet another hole structure 14 fabricated by the first fabrication method.

Through-holes 104 formed in the hole structure 14 were such that the size, d1, of the first open end was 9 μm (rectangular), the size, d2, of the second open end was 10 μm (rectangular), the depth t was 40 μm, and the angle θ was 0.72°. The ratio of the area, s2, of the second open end to the area, s1, of the first open end (s2/s1) was 1.23, and the pitch b between each through-hole 104 was 20 μm.

The various features of the hole structure 14 all satisfy the previously described conditions set for the size, d2, of the second open end (not larger than 50 μm and not smaller than 2 μm), the depth t (not smaller than d2 and smaller than 5.5×d2), the area ratio (s2/s1) (not smaller than 1 and not larger than 9), the angle θ (not smaller than 0° and not larger than 12°), and the pitch b (smaller than 2×d2).

In the fabrication process of the hole structure 14, 10-μm square holes were etched in the electrically conductive opaque layer 30 in the patterning step (corresponding to the step shown in FIG. 1(a)). Therefore, the resist 54 (not shown) used for the fabrication of the hole structure 14 shown in FIG. 7 is formed in a shape resembling a quadratic prism. Using the resist 54 resembling a quadratic prism in shape, the hole structure 14 was formed by depositing Ni to a thickness of 40 μm in the electroforming step (corresponding to the step shown in FIG. 1(e)).

In this way, according to the first fabrication method of the invention, it becomes possible to open through-holes not only in circular or elliptical shape but also in other shapes, which has not been possible with the mechanical working method using a drill. In FIG. 7, square open ends are shown, but the open end shape is not limited to a square shape. The through-holes can be opened in other suitable polygonal shape, for example, a triangular shape including an equilateral triangular shape, a rectangular shape, a rhombic shape, a tetragonal shape, a pentagonal shape including an equilateral pentagonal shape, a hexagonal shape including an equilateral hexagonal shape, or a star-like shape.

The second fabrication method of the present invention will be described below.

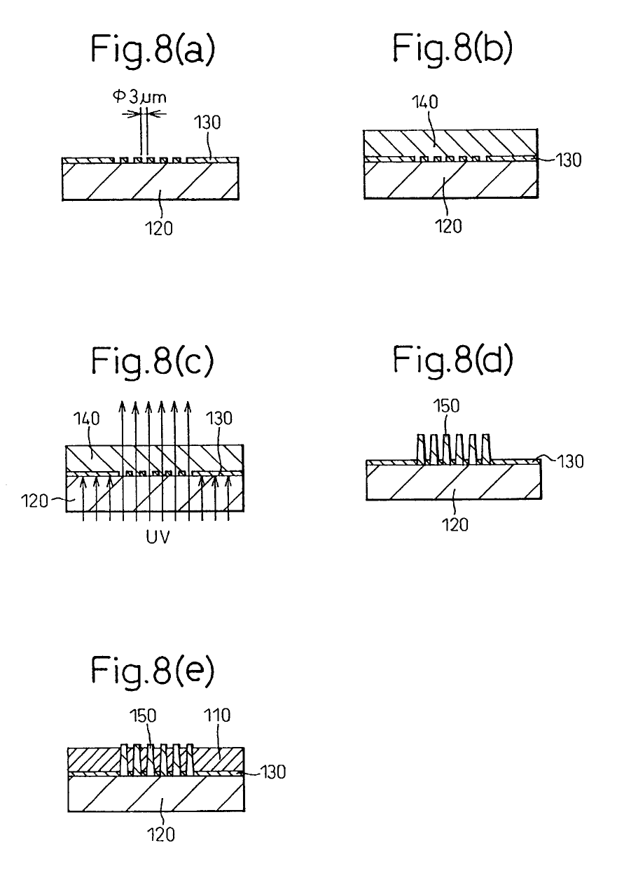

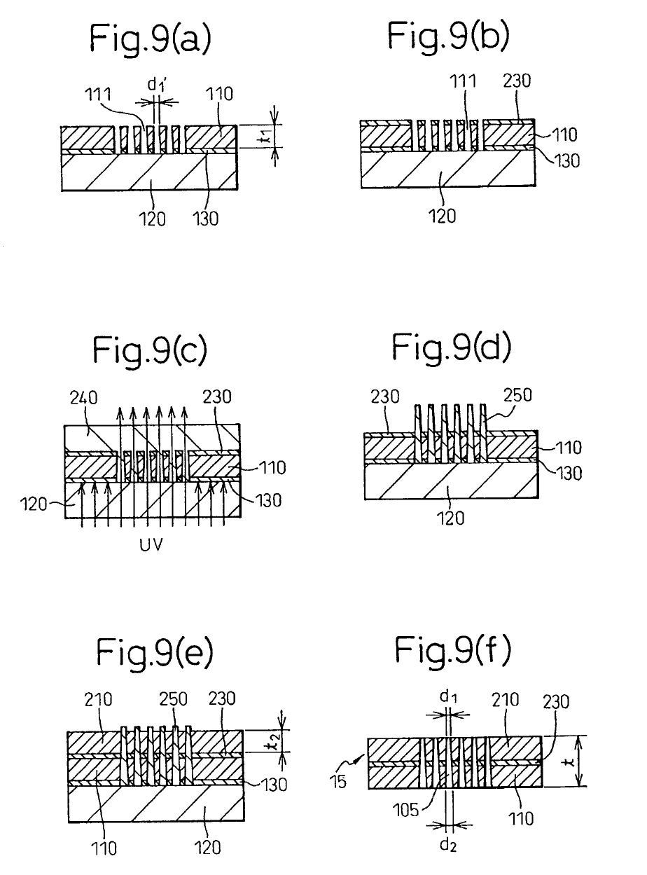

FIG. 8 shows the first half of the process according to the second fabrication method, and FIG. 9 depicts the second half of the process. The first half of the process is similar to the process of the foregoing first fabrication method.

The first half of the process according to the second fabrication method will be described. First, as shown in FIG. 8(a), a first electrically conductive opaque layer 130 is formed and patterned in a desired shape over a transparent substrate 120. The patterning method and the transparent substrate 120 and electrically conductive opaque layer 130 formed here are the same as those used in the first fabrication method. In the illustrated example, the pattern was formed by etching circular holes 3 μm in diameter at a pitch of 8 μm by using the techniques of photolithography and etching.

Next, as shown in FIG. 8(b), a first insoluble photosensitive material 140 is deposited to a specified thickness on one side of the transparent substrate 120 where the first electrically conductive opaque layer 130 is formed. The insoluble photosensitive material is the same as that used in the first fabrication method. In the illustrated example, the insoluble photosensitive material was deposited by spin coating to a thickness of 12 μm. The spin coating was performed for 10 seconds at 5000 rpm.

Then, as shown in FIG. 8(c), ultraviolet radiation (UV) is applied from the other side of the transparent substrate 120 where the first electrically conductive opaque layer 130 is not formed. The insoluble photosensitive material 140 is exposed to the ultraviolet radiation passing through the transparent substrate 120. In the illustrated example, the insoluble photosensitive material 140 was illuminated by ultraviolet light with an energy density of 300 mJ/cm². In this case, the insoluble photosensitive material 140 is exposed according to the pattern of the first electrically conductive opaque layer 130 as the patterned first electrically conductive opaque layer 130 acts as a mask during the exposure. AS previously described, the pattern consists of circularly etched holes 3 μm in diameter and spaced at 8 μm from center to center. The method in which the insoluble photosensitive material formed on the transparent substrate is exposed from the underside of the transparent substrate as described above is called back exposure.

The insoluble photosensitive material 140 is a material which becomes insoluble only in exposed areas. Therefore, in the developing step that follows the exposing step shown in FIG. 8(c), the unexposed portions of the insoluble photosensitive material 140 are removed, leaving the resist 150 shown in FIG. 8(d). For development, a liquid developer special for the negative resist THB-130N (brand name) manufactured by JSR was used, and the developing was performed for one minute at a liquid temperature of 40° C.

The resist 150 has a pattern that matches the pattern of the first electrically conductive opaque layer 130. The resist 150 therefore has a shape substantially resembling a cylinder, that is, the bottom (the side contacting the transparent substrate 120) is circular in shape with a diameter of 3 μm, the top is also circular but is slightly smaller than the bottom, and the height is 12 μm. Here, the resist 150 is not perfectly cylindrical in shape for the reasons described earlier.

Next, as shown in FIG. 8(e), a first structure 110 is formed by electroforming on the first electrically conductive opaque layer 130. In the illustrated example, the first structure 110 of Ni was formed to a thickness of 10 μm by Ni electroforming. In the Ni electroforming process, sulphamic acid Ni was used as the plating material, and the electroforming was performed with a current density of 1 A/dm² for one hour in an aqueous solution held at 50° C. Here, the electrically conductive opaque layer 130 served as the exposure mask for the back exposure as well as the electrode in electroforming.

The second half of the process according to the second fabrication method will be described with reference to FIG. 9.

First, the resist 150 is removed as shown in FIG. 9(a). In the illustrated example, the resist 150 was removed by dissolving it in an aqueous solution of 10% potassium hydroxide (KOH) held at 50° C. By removing the resist 150, holes 111 opened through to the transparent substrate 120 were formed in the first structure 110. The upper open end size, d11, of each hole 111 was 2.5 μm, and the depth t1 was 10 μm (the thickness of the electrically conductive opaque layer 130 is not considered because it is negligible).

After that, a second electrically conductive opaque layer 230 is deposited over the first structure 110 as shown in FIG. 9(b). The second electrically conductive opaque layer 230 need not necessarily be opaque. In the illustrated example, the second electrically conductive opaque layer 230 was constructed using a multi-layer structure consisting of a lower layer (on the first structure 110 side) formed from a 0.03-μm thick chromium (Cr) film and an upper layer formed from a 0.1-μm thick gold (Au) film. The upper and lower layers of the second electrically conductive opaque layer 230 were formed by sputtering which is a form of vacuum film deposition.

In the film deposition step of the second electrically conductive opaque layer 230, the film was not deposited on the transparent substrate 120 exposed through the first holes 111. This was presumably because the depth t1 (10 μm) of each first hole 111 was greater than the first open end size d1 (2.5 μm), preventing the second electrically conductive opaque layer 230 from entering the interior of the first holes 111. According to our experiment, it has been confirmed that when the ratio of the depth t1 of the first hole 111 to the first open end size d1 ′ thereof is larger than 1.5, film is not deposited on the transparent substrate 120. However, depending on the film deposition conditions, there are cases where film is not deposited on the transparent substrate 120 even when the ratio of the depth t1 of the first hole 111 to the first open end size d1′ thereof is within the range of 1 to 1.5. According to the steps shown in FIGS. 8(a) to 8(e), it is easy to form holes having a depth greater than the size of the first open end.

The second electrically conductive opaque layer 230 shown in FIG. 9(b) serves as the electrode in the electroforming step described later. However, when the first structure 110 itself can serve as the electrode, the second electrically conductive opaque layer 230 need not necessarily be deposited.

Next, as shown in FIG. 9(c), a second insoluble photosensitive material 240 is deposited to a specified thickness on one side where the second electrically conductive opaque layer 230 is formed. The second insoluble photosensitive material 240 enters the interior of the holes 111 formed in the first structure 110. In the illustrated example, negative resist THB-130N (brand name) manufactured by JSR was used for the second insoluble photosensitive material 240, and was deposited by spin coating to a thickness of 12 μm on the second electrically conductive opaque layer 230. The spin coating was performed for 10 seconds at 5000 rpm.

Then, as shown in FIG. 9(c), ultraviolet radiation (UV) is applied from the underside of the transparent substrate 120. The second insoluble photosensitive material 240 is exposed to the ultraviolet radiation passed through the transparent substrate 120. At this time, since the first structure 110 acts as an exposure mask, the second insoluble photosensitive material 240 is selectively exposed through the holes 111. In the illustrated example, the second insoluble photosensitive material 240 was illuminated by ultraviolet light with an energy density of 400 mJ/cm².

The second insoluble photosensitive material 240 is a material which becomes insoluble only in exposed areas. Therefore, in the developing step that follows the exposing step shown in FIG. 9(c), the unexposed portions of the second insoluble photosensitive material 240 are removed, leaving the resist 250 shown in FIG. 9(d). In the illustrated example, the resist 250 was formed in a substantially cylindrical shape at the position of each hole 111. The height of the resist 250 was 12 μm from the second electrically conductive opaque layer 230. For development, a liquid developer special for the negative resist THB-130N (brand name) manufactured by JSR was used, and the developing was performed for one minute at a liquid temperature of 40° C.

Next, as shown in FIG. 9(e), a second structure 210 is formed by electroforming on the second electrically conductive opaque layer 230. In the illustrated example, the second structure 210 of Ni was formed to a thickness of 10 μm by Ni electroforming. Since the upper layer of the second electrically conductive opaque layer 230 is formed from Au and the lower layer from Cr, the second structure 210 of Ni is formed on the Au film. Since the Au film is an inactive material and has high electrical conductivity, the Ni electroforming on the Au film produced an extremely good result. As a result, very strong adhesion was achieved between the Au film and the second structure 210 of Ni formed thereon. Further, since the lower layer of the second electrically conductive opaque layer 230 is formed from the Cr film, the Cr film acts as a bonding material between the first structure 110 and the Au film in the upper layer. As a result, the first structure 110 and the second structure 210 could be strongly bonded together. In this way, the second electrically conductive opaque layer 230 serves as an adhesive layer.

Finally, as shown in FIG. 9(f), the resist 250, the first electrically conductive opaque layer 130, and the transparent substrate 120 are removed to complete the fabrication of the hole structure 15 of the present invention. Here, the first electrically conductive opaque layer 130 need not necessarily be removed. In the illustrated example, first the resist 250 was removed by dissolving it in an aqueous solution of 10% potassium hydroxide (KOH) held at 50° C., then the transparent substrate 20 was removed mechanically, and finally the first electrically conductive opaque layer 130 was removed by dissolving it in an acid etchant.

In this way, according to the second fabrication method of the invention, the hole structure 15 could be fabricated that had through-holes 105 such that the size, d1, of the first open end was 2.0 μm (circular), the size, d2, of the second open end was 3 μm (circular), and the depth t was 20 μm (the thickness of the second electrically conductive opaque layer 230 is not considered because it is negligible). The relationship between the depth t and the size, d2, of the second open end in the hole structure 15 fabricated by the second fabrication method can be expressed by t=6.7×d2. The depth t achieved here is far greater than the depth t=5×d2 in the hole structure 12 fabricated by the foregoing first fabrication method. In the illustrated example, s2/s1 was 2.25 and θ was 1.430.

In the second fabrication method, the first structure 110 and second structure 210 made of Ni were formed by Ni electroforming, but it will be appreciated that the material is not limited to Ni. Since electroforming is one form of electroplating, the hole structure described above can be fabricated using any kind of material as long as the material can be deposited by electroplating. Besides Ni, examples of materials that can be used for electroplating include Cu, Co, Sn, Zn, Au, Pt, Ag, Pb, and their alloys.

FIGS. 8 and 9 show an example in which the hole structure 15 is constructed by stacking two structures (first structure 110 and second structure 210) one on top of the other. However, it is also possible to construct a hole structure consisting of three or more structures by repeating the above-described process.

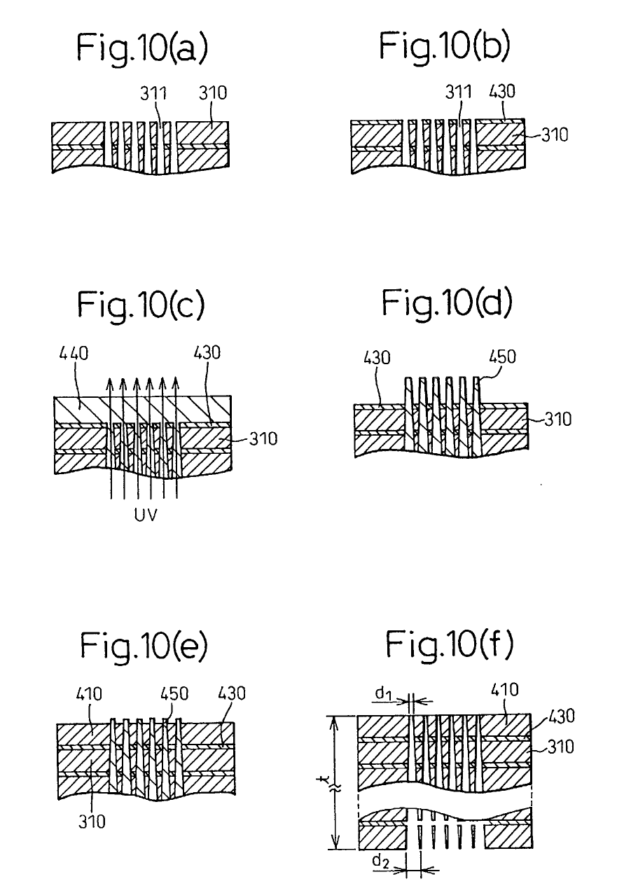

Referring to FIG. 10, a description will be given of the case where the n-th structure 440 is formed on top of the (n−1)th structure 310. It is assumed here that the underlying structures up to the (n−1)th structure 310 shown in FIG. 10(a) are already fabricated using the fabrication method of the invention described above.

Next, as shown in FIG. 10(b), the n-th electrically conductive layer 430 is deposited on the (n−1)th structure 310. In the film deposition step of the n-th electrically conductive layer 430, the film is not deposited on the transparent base substrate (not shown) exposed through the holes 311. This is because the holes 311 are formed through the structure consisting of (n−1) layers and the depth of each hole is sufficiently deep compared with the size of its open end.

Next, as shown in FIG. 10(c), the n-th insoluble photosensitive material 440 is deposited to a specified thickness on one side where the n-th electrically conductive layer 430 is formed. The n-th insoluble photosensitive material 440 enters the interior of the holes 311.

Then, as shown in FIG. 10(c), ultraviolet radiation (UV) is applied from the other side of the structure where the n-th electrically conductive layer 430 is not formed (that is, from the bottom side in the figure). The n-th insoluble photosensitive material 440 is exposed to the ultraviolet radiation passed through the transparent base substrate (not shown). At this time, since the structures up to the (n−1)th structure act as an exposure mask, the n-th insoluble photosensitive material 440 is selectively exposed through the holes 311.

Next, in the developing step that follows the exposing step, a patterned resist 450 is formed as shown in FIG. 10(d). The resist 450 is formed in the position where each hole 311 was formed.

After that, as shown in FIG. 10(e), the n-th structure 410 is formed by electroforming on the n-th electrically conductive layer 430.

Finally, as shown in FIG. 10(f), the resist 450, etc. are removed to complete the fabrication of the n-th structure 410 on top of the (n−1)th structure. By repeating the process shown in FIGS. 10(a) to 10(f) starting from n=1, as many structures as desired can be stacked in sequence.

However, to ensure good development of the insoluble photosensitive material and good removal of the resist, the number of structures stacked should preferably be limited to within six. Further, as previously described with reference to FIG. 5(b), the resist formed by back exposure does not have tapered walls up to ½ of the resist height. Accordingly, if structures, each not higher than one half the height of the resist formed, are stacked one on top of another, through-holes whose inner wall angle is close to 0° can be formed.

With the second fabrication method described above, it becomes possible to form through-holes having a depth t up to 15 times the size, d2, of the open end (on the transparent substrate side) in the bottom of the hole structure.

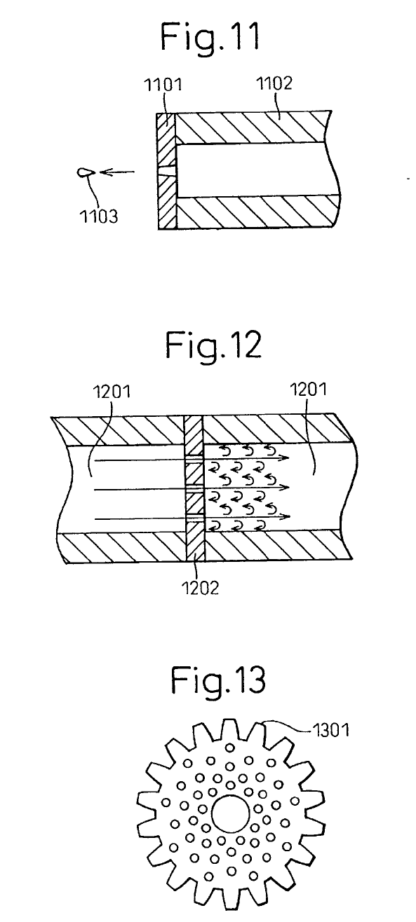

Next, application examples of the hole structures fabricated by the first and second fabrication methods will be described with reference to FIGS. 11 to 17.

FIG. 11 shows an example in which the hole structure according to the present invention is applied for use as a nozzle in a fluid injection apparatus. In FIG. 11, reference numeral 1101 is an inkjet head nozzle for an inkjet printer, 1102 is an inkjet head chamber, and 1103 is an ejected ink droplet. In this example, the hole structure fabricated by the first fabrication method is applied to the nozzle 1101. Other examples of applications in fluid injection apparatuses include nozzles for dispensers, fuel injectors, etc.

FIG. 12 shows an example in which the hole structure according to the present invention is applied for use in a fluid agitating apparatus. In FIG. 12, an agitating member 1202 is placed in a fluid path 1201 to agitate the fluid flowing from left to right in the figure. By flowing a fluid, such as a liquid or air, through microscopic through-holes as illustrated here, agitation at the molecular level becomes possible. In this example, the hole structure fabricated by the first fabrication method is used as the agitating member 1202.

FIG. 13 shows an example in which the hole structure according to the present invention is applied for use as a component of a watch, a micromachine, or the like. In FIG. 13, a large number of through-holes are formed in a gear 1301 to reduce the weight of the gear 1301 itself. In this way, a microscopic component used, for example, in a watch or a micromachine can be reduced in weight while retaining its rigidity.

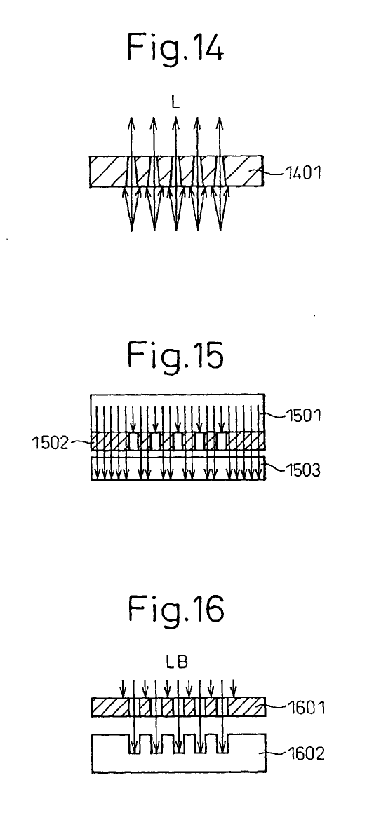

FIG. 14 shows an example in which the hole structure according to the present invention is applied for use as an optical component or an electronic component. In FIG. 14, when light L is passed through an optical component 1401, the rectilinearity of the light passed therethrough improves because of the deep, microscopic through-holes opened through the optical component 1401. Furthermore, according to the present invention, since the spacing or pitch between the through-holes can be reduced, the numeric aperture of an optical component or an electronic component can be increased. Increased numeric aperture contributes to efficient utilization of light or electrons.

FIG. 15 shows an example in which the hole structure according to the present invention is applied for use as a magnetic component. In FIG. 15, reference numeral 1502 indicates a magnetic component using a NiFe electroformed layer. By utilizing the difference in magnetic permeability between portions where through-holes are formed and portions where through-holes are not formed, the magnetic component can be used as a magnetic signal transfer component (stamper) or a magnetic sensor or the like. In the figure, reference numeral 1501 indicates a magnet, and 1503 a magnetic material.

FIG. 16 shows an example in which the hole structure according to the present invention is applied for use as a mask for laser machining. In FIG. 16, LB is laser light, 1601 is the mask for laser machining, and 1602 is a workpiece. Using the hole structure of the present invention, a mask for laser micromachining can be produced.

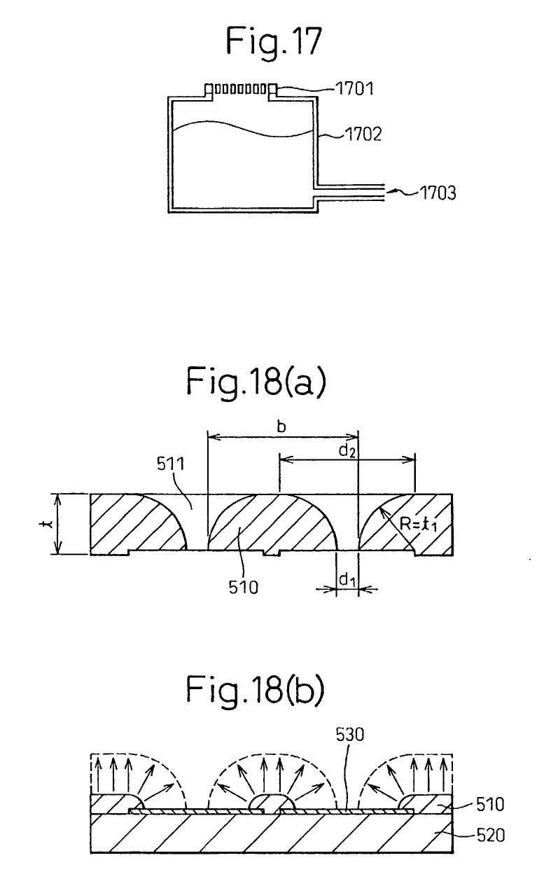

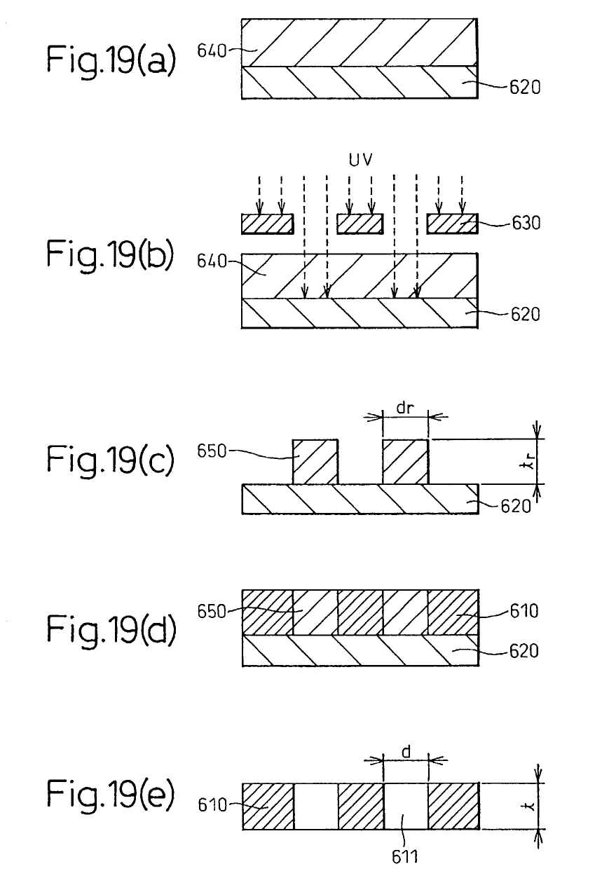

FIG. 17 shows an example in which the hole structure according to the present invention is applied for use as a filter 1701. As shown in FIG. 17, a separator for separating air from a liquid can be constructed that allows only air to pass through the filter 1701 when an air/liquid mixture is introduced into a chamber 1702 through a passage 1703. It is also possible to use the filter 1701 in an ink cartridge for an inkjet printer. In that case, the filter 1701 is installed in an air passage (air communicating passage), 1702 is made the ink chamber, and ink is fed from the ink chamber 1702 into the passage 1703. The filter 1701 serves the purpose of passing air therethrough to maintain the ink chamber 1702 at atmospheric pressure while preventing the ink from leaking outside.

The hole structure according to the present invention can also be applied to a chemical fiber spinning nozzle or sliding component. In this way, the hole structure according to the present invention is expected to find many useful applications.

1. A method for fabricating a hole structure through which is formed a through-hole having a first open end and a second open end not smaller in size than said first open end, said method comprising the steps of:
forming an electrically conductive opaque layer in a prescribed pattern over a transparent substrate;
forming a layer of insoluble photosensitive material on one side of said transparent substrate where said electrically conductive opaque layer is formed;
applying exposure to said insoluble photosensitive material layer from the other side of said transparent substrate where said electrically conductive opaque layer is not formed;
developing said insoluble photosensitive material and thereby forming a resist that matches said prescribed pattern; and
forming said hole structure by electroplating on said one side where said resist has been formed.

2. A hole structure fabrication method as claimed in claim 1, further comprising the step of removing said resist, said electrically conductive opaque layer, and said transparent substrate.

3. A hole structure fabrication method as claimed in claim 2, wherein said hole structure contains at least one element selected from the group consisting of Ni, Cu, Co, Sn, Zn, Au, Pt, Ag, and Pb.

4. A hole structure fabrication method as claimed in claim 2, wherein said exposure is applied by using ultraviolet radiation.

5. A hole structure fabrication method as claimed in claim 2, wherein said through-hole has an interior shape corresponding to said resist.

6. A hole structure fabrication method as claimed in claim 1, further comprising the steps of:
removing said resist;
forming a second layer of insoluble photosensitive material over said hole structure;
applying second exposure to said second insoluble photosensitive material layer from the other side of said transparent substrate where said electrically conductive opaque layer is not formed;
developing said second insoluble photosensitive material and thereby forming a second resist that matches said prescribed pattern;
forming a second hole structure by electroplating on said one side where said second resist has been formed; and
removing said second resist, said electrically conductive opaque layer, and said transparent substrate.

7. A hole structure fabrication method as claimed in claim 6, wherein said second hole structure contains at least one element selected from the group consisting of Ni, Cu, Co, Sn, Zn, Au, Pt, Ag, and Pb.

8. A hole structure fabrication method as claimed in claim 6, wherein said exposure or said second exposure is applied by using ultraviolet radiation.

9. A hole structure fabrication method as claimed in claim 6, wherein said hole structure and said second hole structure are bonded together.

10. A hole structure fabrication method as claimed in claim 6, wherein said through-hole has a first interior shape corresponding to said resist and a second interior shape corresponding to said second resist.

11. A hole structure fabrication method as claimed in claim 10, wherein said first interior shape and said second interior shape are substantially equal in size.

12. A hole structure fabrication method as claimed in claim 10, wherein said first interior shape is larger in size than said second interior shape.

13. A hole structure fabrication method as claimed in claim 6, further comprising the step of forming a second electrically conductive layer between said hole structure and said second insoluble photosensitive material.

14. A hole structure through which is opened a through-hole having a first open end and a second open end not smaller in size than said first open end, wherein
said hole structure is formed by back exposure and electroforming processes,
said through-hole has an interior shape corresponding to the shape of said resist,
the size, d, of said second open end is not smaller than 2 μm and not larger than 50 μm, and
said through-hole has a depth t larger than d but not larger than 15d.

15. A hole structure as claimed in claim 14, wherein
said back exposure and electroforming processes comprise the steps of:
forming an electrically conductive opaque layer in a prescribed pattern over a transparent substrate;
forming a layer of insoluble photosensitive material on one side of said transparent substrate where said electrically conductive opaque layer is formed;
applying exposure to said insoluble photosensitive material layer from the other side of said transparent substrate where said electrically conductive opaque layer is not formed;
developing said insoluble photosensitive material and thereby forming a resist that matches said prescribed pattern; and
applying electroplating on said one side where said resist has been formed.

16. A hole structure as claimed in claim 15, wherein when the area of said first open end is denoted by s1 and the area of said second open end by s2, s2/s1 is not smaller than 1 and not larger than 9.

17. A hole structure as claimed in claim 16, wherein when the angle that an inner wall of said through-hole makes with a centerline of said through-hole is denoted by θ, θ is not smaller than 0° and not larger than 12°.

18. A hole structure as claimed in claim 16, wherein said depth t is not smaller than 1.5d and not larger than 5d.

19. A hole structure as claimed in claim 16, wherein said hole structure has a plurality of through-holes formed at a pitch b which is not larger than 2t.

20. A hole structure as claimed in claim 16, wherein said first or said second open end is circular or elliptical in shape.

21. A hole structure as claimed in claim 16, wherein said first or said second open end is polygonal in shape.

22. A hole structure as claimed in claim 15, wherein when the angle that an inner wall of said through-hole makes with a centerline of said through-hole is denoted by θ, θ is not smaller than 0° and not larger than 12°.

23. A hole structure as claimed in claim 22, wherein when the area of said first open end is denoted by s1 and the area of said second open end by s2, s2/s1 is not smaller than 1 and not larger than 9.

24. A hole structure as claimed in claim 22, wherein said depth t is not smaller than 1.5d and not larger than 5d.

25. A hole structure as claimed in claim 22, wherein said hole structure has a plurality of through-holes formed at a pitch b which is not larger than 2t.

26. A hole structure as claimed in claim 22, wherein said first or said second open end is circular or elliptical in shape.

27. A hole structure as claimed in claim 22, wherein said first or said second open end is polygonal in shape.

28. A hole structure through which is formed a through-hole having a first open end and a second open end not smaller in size than said first open end, wherein
the size, d, of said second open end is not smaller than 2 μm and not larger than 50 μm, and
said through-hole has a depth t larger than d but not larger than 15d.

29. A hole structure as claimed in claim 28, wherein when the area of said first open end is denoted by s1 and the area of said second open end by s2, s2/s1 is not smaller than 1 and not larger than 9.

30. A hole structure as claimed in claim 29, wherein when the angle that an inner wall of said through-hole makes with a centerline of said through-hole is denoted by θ, θ is not smaller than 0° and not larger than 12°.

31. A hole structure as claimed in claim 29, wherein said depth t is not smaller than 1.5d and not larger than 5d.

32. A hole structure as claimed in claim 29, wherein said hole structure has a plurality of through-holes formed at a pitch b which is not larger than 2t.

33. A hole structure as claimed in claim 29, wherein said first or said second open end is circular or elliptical in shape.

34. A hole structure as claimed in claim 29, wherein said first or said second open end is polygonal in shape.

35. A hole structure as claimed in claim 28, wherein when the angle that an inner wall of said through-hole makes with a centerline of said through-hole is denoted by θ, θ is not smaller than 0° and not larger than 12°.

36. A hole structure as claimed in claim 35, wherein when area of said first open end is denoted by s1 and area of said second open end by s2, s2/s1 is not smaller than 1 and not larger than 9.

37. A hole structure as claimed in claim 35, wherein said depth t is not smaller than 1.5d and not larger than 5d.

38. A hole structure as claimed in claim 35, wherein said hole structure has a plurality of through-holes formed at a pitch b which is not larger than 2t.

39. A hole structure as claimed in claim 35, wherein said first or said second open end is circular or elliptical in shape.

40. A hole structure as claimed in claim 35, wherein said first or said second open end is polygonal in shape.
